(19) United States
(12) Patent Application Publication
(10) Pub. No.: US 2003/0157222 A1
(43) Pub. Date: Aug. 21, 2003

(54) Freezer to oven biscuit swirl

(76) Inventors: Leola Henry, Brooklyn Park, MN (US); John Graves, St. Paul, MN (US); Cara Yarusso, Bloomington, MN (US); Jalayne Martin, Falcon Heights, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/001,497

(22) Filed: Nov. 14, 2001

(51) Int. Cl. A23G 3/00

(52) U.S. Cl. 426/94

(57) ABSTRACT

Frozen, unproofed biscuit swirl products are provided that are capable of being baked without an intermediate thawing or proofing step. The biscuit swirls comprise a biscuit dough and a smear layer having compatible water activities, wherein the biscuit dough is formed in a swirl with the smear layer located between adjacent portions of the biscuit dough.

### FIELD OF THE INVENTION

The present invention relates to freezer to oven biscuit products. More specifically, the present invention relates to luxuriant biscuit swirls that can be stored in the freezer and placed directly in an oven to bake.

### BACKGROUND OF THE INVENTION

In its origin as a food type, biscuits were not a very appetizing food. Named “pain bis-cuit” or “twice cooked bread,” they originally were very hard and dry, and were especially useful to the traveler and the soldier because they were very light and did not spoil. Modem biscuits are more appetizing in that they are not twice baked to such a dry state. Modem biscuits are characterized by being prepared using chemical leavener rather than yeast, and the biscuit dough is mixed only enough to incorporate all the ingredients without developing the gluten in the dough. The end product preferably has a light and moist crumb texture that has been described as flaky. The characteristic flavor of a biscuit is generally bland in nature.

Dough products that can be prepared by taking them directly from storage in the freezer and placing them in the oven for baking are particularly desirable because of the convenience to the consumer. Such dough products typically use chemical leavening systems consisting of a bicarbonate and a leavening acid to provide expansion of the product without the proofing step that is required in yeast containing products. U.S. Pat. No. 5,451,417 discloses such a product and the attempts to incorporate yeast flavor to avoid the characteristic biscuit taste and chewy sensations. See, for example, column 1, lines 62-66 and column six, lines 66-68. The product described in this patent is in the format of a baked roll.

The provision of a prebaked, chemically leavened frozen biscuit is disclosed in U.S. Pat. No. 4,746,526. This patent relates to preparation of a conventional biscuit dough to provide convenience to the consumer. The invention described therein comprises first preparing a biscuit dough and baking it, followed by tempering or moisture treating the upper crust of the biscuit. The biscuit is then proofed, baked, and frozen for storage. The frozen prebaked biscuit is reheated by the consumer.

U.S. Pat. No. 5,965,180 discloses glazes that may be applied to dough products to produce a finish product with increased horizontal dimensions over that which would be expected based on raw dimensions of unbaked dough products. In preferred embodiments, the dough is frozen and can be baked directly from the frozen state without an intermediate cooking step. See column six, lines 42-50. This glaze may additionally be applied to biscuits. See column 8, line 19.

Luxuriant rolls, such as breakfast rolls having cinnamon or orange flavor, are traditionally provided as yeast containing doughs that are a bread-like product rather than a biscuit. They generally are sold immediately after preparation, or may alternatively be proofed and frozen for sale, with final baking performed by the consumer after purchase. Some such products are frozen prior to proofing, and must be thawed and proofed by the consumer prior to baking. Other such products are frozen prior to proofing, and are provided with a leavening system such that they may be placed immediately in the oven without thawing. These products are limited in size because it is difficult to obtain the increase in size desired and completeness of cooking in a large unthawed luxuriant roll product.

### SUMMARY OF THE INVENTION

The present invention provides a frozen unproofed, unbaked biscuit swirl capable of being baked without an intermediate thawing or proofing step. The biscuit swirl is made from a nonlaminated biscuit dough comprising flour, water, chemical leavening system, sugar, and fat. A smear layer is applied to the biscuit dough, and has a water activity that is compatible with the biscuit dough. The biscuit dough is formed in a swirl with the smear layer located between adjacent portions of the dough.

### BRIEF DESCRIPTION OF THE DRAWING

FIG. 1 is a perspective view of an embodiment of a biscuit swirl of present invention.

FIG. 2 is a top view of the embodiment of a biscuit swirl of the present invention shown in FIG. 1.

FIG. 3 is a top view of an alternative embodiment of a biscuit swirl of the present invention, having only one complete turn of the dough upon itself to form a single swirl.

FIG. 4 is a top view of an embodiment of a biscuit swirl of the present invention having two turns of the dough upon itself to form a double swirl.

### DETAILED DESCRIPTION OF THE INVENTION

The present invention provides a luxuriant biscuit swirl that can be easily prepared by the consumer, with a reliable size, appearance and excellent flavor provided throughout the biscuit swirl. Through the present invention, the biscuit swirl is conveniently provided in any size desired, from very small to very large. The format of the biscuit swirl as provided herein enables a unique flavor combination that has heretofore been unavailable with unparalleled convenience to the manufacturer and consumer.

The biscuit swirl at present invention is provided in a frozen, unproofed and unbaked form. This biscuit swirl is capable of being baked without an intermediate thawing or proofing step.

For purposes of the present invention, the term “unproofed” means that the biscuit dough is provided in a state wherein it contains sufficient unactivated leavening agent that the biscuit swirl product will at least double in volume when baked from the frozen state. Thus, while some chemical leavening agent may have interacted with ingredients in the dough process during mixing to generate some gases, a sufficient amount of the leavening agent is still available to be utilized to proof the dough during baking. For purposes of the present invention, the term “frozen” describes dough products that are maintained at a temperature below the freezing point of water, regardless of whether all ingredients in the dough product are actually in the frozen state.

The biscuit dough of the present invention is a dough comprising flour, water, chemical leavening system, sugar and fat, characterized by being an underdeveloped dough. Thus, the biscuit dough is prepared by mixing the dough composition only enough to incorporate all the ingredients without fully developing the gluten in the dough. As is appreciated by those of skill in the baking art, a biscuit dough is distinct from bread-like doughs due to the degree of development of the dough. Thus, a biscuit dough is stickier and it tends to break when stretched. A bread dough is more extensible than a biscuit dough. A tool to quantify the nature of the extent of development of the dough is a farinograph, which is a common flour and dough quality measuring device which measure the resistance of the dough to mixing. As dough is mixed, the resistance to mixing increases until a peak is reached, after which the resistance to mixing decreases. Typical bread doughs tend to peak within about 3 minutes, indicating that the dough is fully developed. A biscuit dough, in contrast, will take longer to reach a peak resistance, indicating that the dough is underdeveloped. Biscuit doughs typically reach a peak of resistance in a time period greater than about 7 minutes, and preferably greater than about 10 minutes. The biscuit dough is mixed using a mixer suitable for the size batch to be prepared.

For purposes of the present invention, a “smear layer” is a non-dough icing or filling composition provided between dough portions of the biscuit swirl of the present invention, wherein the smear layer provides a distinct flavor sensation and is visibly distinct from the biscuit dough (determined by unmagnified visual inspection) in the biscuit swirl product after baking. The smear layer provides flavor enhancement and a texture differential throughout the biscuit swirl. The smear layer further enhances the appearance of the biscuit swirl and also provides separation between portions of the biscuit dough.

In contrast to the present invention, a laminated dough is a dough that has been rolled out to into very thin sheets with a layer of fat added between the dough sheets. The layers of dough and fat in a laminated dough product are then assembled to make a unitary product. Upon baking of the laminated dough product, the fat layer is at least partially absorbed into the dough layer and is not separately identifiable as an extant layer of the baked product. Instead, the layers of the laminated dough separate during the baking process, as the fat layer is absorbed into the dough or is otherwise dissipated. The laminated dough therefore exhibits excellent expansion properties upon baking, and also exhibits a “flaky” texture. The biscuit swirl products of the present invention are not laminated dough products, because the smear layer remains as a visible layer in the product after baking.

Turning now to components of the biscuit dough, the flour to be used may be any suitable flour for manufacture of biscuits. Wheat flour is preferred, although non-wheat flours may be used in conjunction with wheat flours or alone if desired. Appropriate flours for use in the present invention include whole grain flours, flours with the bran and/or germ removed, bleached or unbleached, or combinations thereof. In the event that a non-wheat flour is used, addition of gluten may be desirable.

Water is a necessary ingredient in biscuit doughs of the present invention. Water is added to the dough as liquid water, ice, or it is added via hydrated ingredients. Ice is added to supply water to doughs in order to keep the combination cool during mixing. Water is present in the dough in the amount up to about 50 percent by weight, more preferably between about 25 and 45 percent by weight.

For purposes of the present invention, a chemical leavening agent is a combination of chemical ingredients that react to produce carbon dioxide. Preferably, these chemical ingredients are a combination of an acid and a base that react to release carbon dioxide, into the dough and thereby increase the volume of the dough. Suitable leavening acids are generally known in the industry and include but are not limited to citric acid, sodium acid pyrophosphate (SAPP), sodium aluminum phosphate (SALP), monocalcium phosphate (MCP), dicalcium phosphate (DCP), sodium aluminum sulfate (SAS), anhydrous monocalcium phosphate (AMCP), dimagnesium phosphate (DMP), dicalcium phosphate dihydrate (DCPD), gluconodelta lactone (GDL) and mixtures thereof. Suitable bases used in leavening agents generally include a carbonate and/or a bicarbonate salt. Suitable carbonate and bicarbonate salts include, for example, sodium carbonate, potassium carbonate, sodium bicarbonate (commonly known as baking soda), potassium bicarbonate, ammonium bicarbonate and mixtures thereof. An example of a preferred chemical leavening agent is the combination of sodium bicarbonate and glucono-delta-lactone. Typically, the leavening agent is provided as about 1% to about 6% by weight of the dough.

Fat, when provided as a component of the biscuit dough, improves the volume of the dough and enhances the mouthfeel, texture, and flavor of the baked product. A shortening that is solid at room temperature (i.e. “plastic”) is preferred and is used in the range of 12% to 20% by weight of the dough. The plastic shortening could be emulsified or non-emulsified and have the form of a chip, pellet, flake or any variation thereof.

Protein is a preferred optionally additional ingredient, that may be added to provide structural and textural benefits in addition to frozen shelf-life extension and coloration. Protein may be used in a range between 1% and 10% by weight. Protein sources include dairy (e.g. milk and egg), wheat, high protein flour and any combination thereof.

Other ingredients may be added to the dough such as sweeteners, preservatives, flavorings, spices or browning agents and the like. The dough can also include a sweetener, which may be provided either as a natural or artificial sweetener or as a liquid or dry ingredient. Suitable sweeteners include but are not limited to lactose, sucrose, fructose, dextrose, maltose, corresponding sugar alcohols, corn syrup, malt, hydrogenated corn syrup, maltodextrin, and mixtures thereof Such sweeteners may act either or both as flavoring agents, texturizing, or browning agents.

Biscuit doughs of the present invention may optionally include additional flavoring agents. Such flavoring agents include but are not limited to such ingredients as salt, milk and milk products, eggs and egg products, cocoa, whey, malt, yeast, yeast extract, inactivated yeast, spices, herbs, and vanilla. The optional flavoring agent preferably comprises from above about 0.1 percent by weight, and more preferably from about 0.5 and about 5.0 percent by weight of the dough.

Besides flavoring agents, the dough can further include preservatives, emulsifiers and hydrocolloids. Suitable emulsifiers include, for example, mono- and di-glycerides of fatty acids, propylene glycol mono- and di-esters of fatty acids, glycerol-lacto esters of fatty acids, ethoxylated mono-glycerides, lecithin, protein, and mixtures thereof. Preferred emulsifiers include mono-glycerides and mixtures of propylene glycol mono- and di-esters of fatty acids, mono-glycerides and lecithin. Suitable hydrocolloids assist in building viscosity, binding water, and trapping gases, which include, for example, starches, gums (e.g. xanthan and guar), cellulose, and carageenan. Preservatives, emulsifiers, and hydrocolloids comprise combined preferably less than about 5 percent by weight of the dough, and each preferably between about 0.1 percent and about 2.5 percent by weight of the dough. Suitable preservatives provide shelf-life extension for the baked product, which include, for example, potassium sorbate, sorbic acid, sodium propionate, and sodium diacetate.

Preferably, the biscuit dough has a water activity of between about 0.93 and 0.97.

The smear layer is preferably formulated so that it does not exhibit separation or syruping during frozen storage or under abusive storage conditions wherein the product is subject to freeze-thaw cycling. The smear layer is preferably formulated to have a fat component, and additionally to have sufficient additional components that are not absorbed into the dough layer or otherwise dissipated during baking, so that the smear layer remains as a visible layer in the biscuit swirl after baking. Additional optional ingredients include viscosity controlling agents, such as hydrocolloid gums, gel-forming proteins, modified starches and the like and combinations thereof. The smear layer may additionally comprise colorants and preservatives. The smear layer of the present invention may be sweet or savory, depending on the desired flavor sensation for the ultimate product. Preferred smear layer compositions may be prepared as the fillings described in U.S. Pat. No. 6,280,782, the disclosure of which is incorporated herein by reference.

Preferred smear layer formulations are sweet tasting. When the smear layer is sweet, it preferably has an additional flavor imparted thereto, such as cinnamon, maple syrup, or fruit such as orange, blueberry, or any other desired flavor. Particularly preferred smear layer compositions are modified icing formulations incorporating the desired flavorant in the icing as disclosed in WO 01/19203 (U.S. patent application Ser. No. 09/396,960), the disclosure of which is incorporated herein by reference. Most preferably, the smear layer contains no more than about 50 percent sucrose. A preferred embodiment of the smear layer the present invention comprises margarine, high fructose corn syrup, sucrose, and flavorant.

Alternatively, the smear layer may be savory in flavor, such as cheese flavored, beef, chicken and the like. When the smear layer is savory, the smear layer composition preferably comprises a base savory component, such as cheese, beef gravy, chicken gravy or the like, that includes a fat in this base component. Flavorants, such as herbs and spices, are additionally provided according to taste.

Most preferably the smear layer is formulated so that it is spreadable at room temperature. That is, the smear layer may be applied to the layer of biscuit dough and spread with a knife, coater bar or other appropriate spreading device without displacing or tearing the dough. Alternatively, the smear layer may be formulated such that it is highly viscous or even stiff at room temperature, but which is rendered flowable or spreadable by application of heat. In such an embodiment, the smear layer is heated for uniform application to the biscuit dough.

The smear layer has a water activity that is compatible with the biscuit dough. By this is meant that the water activities of the biscuit dough and the smear layer are selected such that water transfer from one material to another during frozen storage has minimal deleterious effects to either the smear layer or the dough of the biscuit swirl product. Preferably, the water activity of the smear layer and the dough composition is selected such that there is no deleterious visual effect to either component over the expected storage time of the product. Additionally, the water activity of the smear layer and the dough composition is preferably selected such that there is no deleterious organoleptic effect to either component over the expected storage time of the product. Preferably, the smear layer has a water activity between about 0.77 and 0.84.

The biscuit swirl is formed in a characteristic swirl format having a layer of dough rolled upon itself to form a spiral structure. A smear layer is located between the dough spiral portions, thereby preventing contact of adjacent biscuit portions of the dough of the biscuit swirl. Because the smear layer is located between spiral elements of the biscuit dough, the biscuit dough is discontinuous. While not being bound by theory, it is believed that the discontinuous nature of the non-laminated biscuit dough in the spiral assists in enabling the biscuit swirl of varying sizes to thoroughly bake from a frozen state.

Typically, the biscuit is constructed by first sheeting the biscuit dough to a thickness of between at least 0.5 mm, preferably between about 2 to about 15 mm, and more preferably between about 5 to about 10 mm. A smear is then applied to the top surface of the biscuit dough to cover the sheet of biscuit dough while leaving a margin at one end for the dough to adhere to itself at the end of the roll. The smear layer is preferably applied to the sheet of dough so that the smear layer constitutes between about 10 to about 30 percent of the total weight of the biscuit swirl product prior to freezing, and more preferably between about 15 to about 25% of the total weight of the biscuit swirl product prior to freezing. The biscuit dough having the layer of smear applied thereto is then rolled up, so that the smear layer is located between the curls of the resulting roll. Preferably, the biscuit dough is rolled on itself at least one complete turn so that it overlaps a sufficient amount to allow the bottom surface of the sheet to contact the top surface of the sheet. More preferably, the biscuit dough is rolled on itself to at least two complete turns. The roll is then sliced substantially transversely at the desired thickness to form swirls. The individually sliced swirls are then packaged in a matter suitable for freezing, storage and transport to a customer for baking.

The biscuit swirl of the present invention may be provided in any size desired by the ultimate consumer. Particularly preferred sizes are less than two ounces, or greater than three ounces, five ounces, and seven ounces. With conventional bread-type doughs, luxuriant swirls typically cannot be provided in a freezer to oven format in a size greater than 7 ounces, because uneven expansion and/or baking is experienced due to the size of the swirl product. It has surprisingly been found that the present biscuit swirls may be provided in sizes greater than 7 ounces, and even as large as 11 ounces or higher, with very acceptable cooking and flavor results.

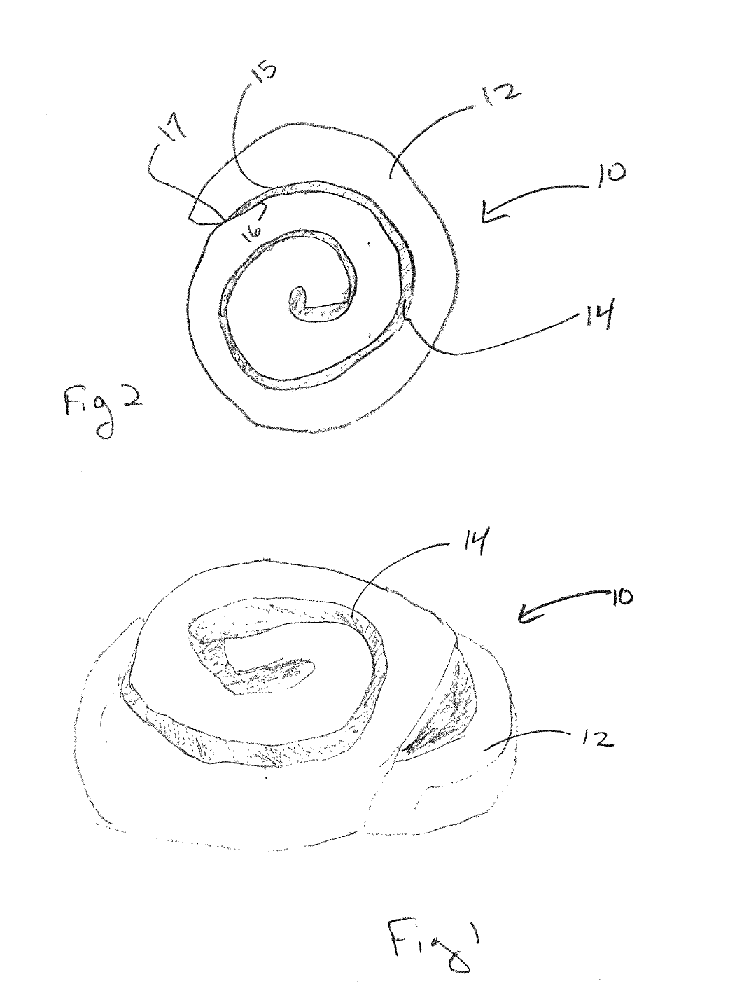

Turning now to the drawings, wherein like numerals indicate like parts, FIG. 1 is a perspective view of an embodiment of the present invention, and FIG. 2 is a top view of an embodiment of the present invention, wherein biscuit swirl 10 comprises dough 12 and having smear layer 14 located between different adjacent surfaces of the dough 12 when in the swirl configuration. As described above, dough 12 is initially provided as a sheet, with a smear layer 14 applied thereto. Dough 12 is rolled upon itself with smear layer 14 located between curls of dough 12. Bottom surface 15 of dough 12 is allowed to contact top surface 16 of dough 12 at contact point 17. Bottom surface 15 and top surface 16 are moistened with water or other suitable liquid to provide adhesion of the dough on itself. As shown, the outer perimeter shape impression of biscuit swirl 10 from the top view is a circle. Alternatively, the biscuit swirl 10 may vary in the number of swirls (curls) and have an outer perimeter shape impression of a rectangle, square, triangle, hexagon, or any other desired shape.

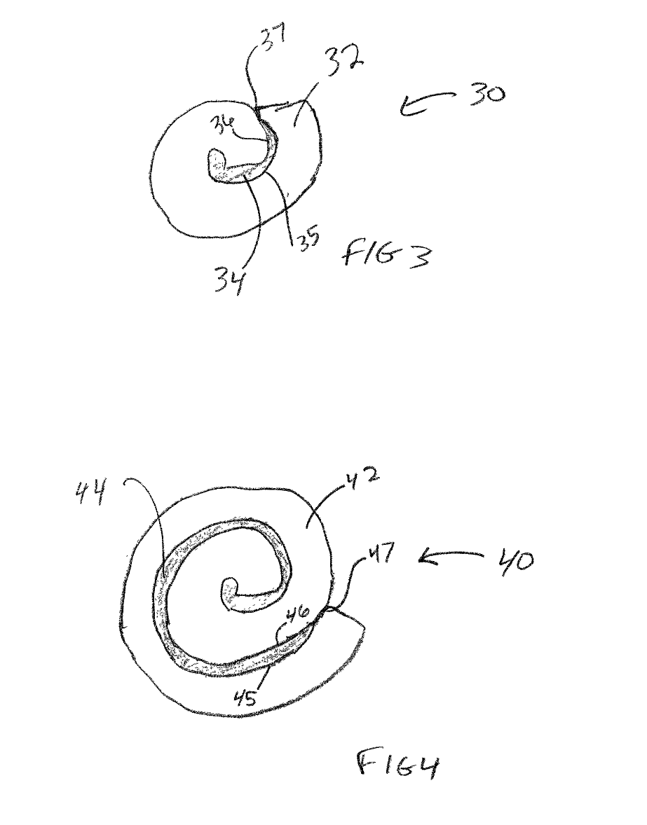

FIG. 3 is a top view of another embodiment of the present invention, wherein biscuit swirl 30 comprises dough 32 and having smear layer 34 located between different adjacent surfaces of the dough 32 when in the swirl configuration. The embodiment as shown in FIG. 3 has dough 32 rolled on itself only one complete turn, so that bottom surface 35 of dough 32 is allowed to contact top surface 36 of dough 32 at contact point 37. As with the embodiment of FIG. 2 above, bottom surface 35 and top surface 36 are moistened with water or other suitable liquid to provide adhesion of the dough on itself.

FIG. 4 is a top view of another embodiment of the present invention, wherein biscuit swirl 40 comprises dough 42 and having smear layer 44 located between different adjacent surfaces of the dough 42 when in the swirl configuration. The embodiment as shown in FIG. 4 has dough 42 rolled on itself with two complete turns, so that bottom surface 45 of dough 42 is allowed to contact top surface 46 of dough 42 at contact point 47. As with the embodiments of FIGS. 2 and 3 above, bottom surface 45 and top surface 46 are moistened with water or other suitable liquid to provide adhesion of the dough on itself.

The invention will further be described by reference to the following non-limiting examples.

### EXAMPLE 1

This experiment was done to identify the most suitable biscuit dough for this application. Freezer-to-oven biscuit doughs with cinnamon smear in accordance with the present invention were prepared according to the following formulations and utilizing the following processes.

Dough

TABLE 1
Dough Formulation 1A

| Ingredient | Weight % |
|---|---|
| Flour | 47.88 |
| Buttermilk | 12.50 |
| Sugar | 1.75 |
| Salt | 0.33 |
| Soda | 1.28 |
| SALP | 0.65 |
| SAPP | 0.88 |
| Caseinate | 0.40 |
| Soybean Oil | 0.04 |
| Shortening | 12.47 |
| Water | 21.82 |
| Total | 100.00 |

TABLE 2
Dough Formulation 1B

| Ingredient | Weight % |
|---|---|
| Flour | 46.0 |
| Buttermilk | 9.74 |
| Sugar | 1.00 |
| Salt | 0.33 |
| Soda | 1.25 |
| SALP | 1.02 |
| SAPP | 0.54 |
| Emulsifiers | 0.63 |
| Caseinate | 0.50 |
| Soybean Oil | 0.06 |
| Shortening | 16.81 |
| Water | 22.12 |
| Total | 100.00 |

TABLE 3
Dough Formulation 1C

| Ingredient | Weight % |
|---|---|
| Flour | 46.81 |
| Whey | 1.5 |
| Buttermilk | 1.46 |
| Salt | 0.87 |
| Soda | 1.31 |
| SALP | 1.05 |
| SAPP | 0.60 |
| Sugar | 1.30 |
| Corn Syrup Solids | 0.50 |
| Butter Flavor | 0.10 |
| Carageenan | 0.03 |
| Albumen | 0.29 |
| Caseinate | 0.58 |
| Soybean Oil | 0.06 |
| Shortening | 15.72 |
| Water | 27.82 |
| Total | 100.00 |

TABLE 4
Dough Formulation 1D

| Ingredient | Weight % |
|---|---|
| Flour | 46.79 |
| Wheat Protein | 0.20 |
| Salt | 1.03 |
| Soda | 1.30 |
| SALP | 1.05 |
| SAPP | 0.60 |
| Sugar | 2.7 |
| Dough Conditioner | 0.80 |
| Butter Flavor | 0.10 |
| Caseinate | 0.90 |
| Soybean Oil | 0.07 |
| Shortening | 14.26 |
| Water | 30.2 |
| Total | 100.00 |

I. Dough Mixing and Sheeting

The dough was prepared by pre-blending the dry ingredients (including the shortening). The water was then added and the mixture was blended until a dough was formed. The dough was sheeted to the desired thickness. In this case, the dough thickness was approximately 8 mm.

Smear (Filling)

The following smear formulation was utilized for the dough for all of the doughs outlined in Tables 1 through 4.

Smear Formulation

| Ingredient | Weight % |
|---|---|
| Sugar | 44.78 |
| Shortening | 14.80 |
| Molasses | 5.00 |
| Corn Syrup | 7.50 |
| Water | 13.02 |
| Salt | 0.60 |
| Flour | 2.00 |
| Nonfat Milk Replacer | 2.00 |
| Starch | 2.00 |
| Cinnamon | 8.30 |
| Total | 100.00 |

II. Preparation of Smear

The smear was prepared by first mixing the sweeteners and fat. The water was then mixed in, followed by the remaining dry ingredients. The ingredients were mixed until a homogeneous mixture was obtained.

III. Formation of Cinnamon Swirls

Cinnamon swirls were prepared with 80 wt % of the dough formed in Step I and 20 wt % of the cinnamon smear prepared in Step II.

The sheeted dough was cut into 18″ strips to obtain a 5 ounce finished swirl. The cinnamon smear was evenly spread over the dough strip, leaving a 1″ space at one edge of the dough (the sealing edge). Water was then added to the sealing edge to moisten the dough in an amount effective to obtain adequate adhesion of the dough unto itself. The dough was then torpedo rolled from the top of the strip to the sealing edge. Next, the dough roll was cut transversely into 1″ pieces to form swirls 5 ounces in weight. The cinnamon swirls were then placed on sheet pans and frozen to a temperature of 0° F. or below. The frozen swirls were then removed from the freezer, placed on a pan lined with parchment paper, and baked in a convection oven at 325° F. for 18-20 minutes or until the internal temperature reached 185° F.

IV. Results

All of the biscuit dough formulations in Tables 1 through 4 were acceptable for the biscuit swirl application. However, the formulation in Table 4 resulted in a biscuit cinnamon swirl that had the best combination of visual and organoleptic attributes, as well as baked specific volume. Biscuit cinnamon swirls made with dough formulations in Tables 1 through 3 were slightly more dry and crumbly in texture and had baked specific volumes of approximately 2.2. The biscuit cinnamon swirl that was made from the dough formulation in Table 4 had a slightly crisp and tender outer layer with a moist internal crumb. The baked specific volume of the said cinnamon swirl was approximately 2.4.

### EXAMPLE 2

This experiment was conducted to identify a spreadable, indulgent, wet cinnamon smear that exhibits minimal syruping during frozen storage and under abusive temperature cycling conditions. A wet smear is defined as one that has a moist, fluid appearance after the cinnamon swirl is baked. Syruping is defined as the release of a sticky solution, mainly a combination of sugars and water, from the smear of the cinnamon swirl during frozen storage or under temperature abusive conditions.

Dough formulation 1D in Table 4 was used for all of the smears in this example.

TABLE 6
Smear Formulation 1A

| Ingredient | Weight % |
|---|---|
| Sugar | 42.7 |
| Shortening | 12.20 |
| Molasses | 3.70 |
| Corn Syrup | 6.20 |
| Water | 18.23 |
| Salt | 0.60 |
| Flour | 2.00 |
| Nonfat Milk Replacer | 2.00 |
| Starch | 2.00 |
| Cinnamon | 10.38 |
| Total | 100.00 |

TABLE 7
Smear Formulation 1B

| Ingredient | Weight % |
|---|---|
| Sugar | 45.35 |
| Shortening | 10.87 |
| Molasses | 3.04 |
| Corn Syrup | 5.54 |
| Water | 18.23 |
| Salt | 0.60 |
| Flour | 2.00 |
| Nonfat Milk Replacer | 2.00 |
| Starch | 2.00 |
| Cinnamon | 10.38 |
| Total | 100.00 |

TABLE 8
Smear Formulation 1C

| Ingredient | Weight % |
|---|---|
| Sugar | 48.00 |
| Shortening | 12.15 |
| Molasses | 3.68 |
| Corn Syrup | 6.18 |
| Water | 13.02 |
| Salt | 0.60 |
| Flour | 2.00 |
| Nonfat Milk Replacer | 2.00 |
| Starch | 2.00 |
| Cinnamon | 10.38 |
| Total | 100.00 |

TABLE 9
Smear Formulation 1D

| Ingredient | Weight % |
|---|---|
| Sugar | 45.35 |
| Shortening | 13.48 |
| Molasses | 4.34 |
| Corn Syrup | 6.84 |
| Water | 13.02 |
| Salt | 0.60 |
| Flour | 2.00 |
| Nonfat Milk Replacer | 2.00 |
| Starch | 2.00 |
| Cinnamon | 10.38 |
| Total | 100.00 |

TABLE 10
Smear Formulation 1E

| Ingredient | Weight % |
|---|---|
| Sugar | 46.56 |
| Butter | 21.16 |
| High Fructose Corn Syrup | 4.68 |
| Water | 13.22 |
| Salt | 0.51 |
| Flour | 1.69 |
| Nonfat Milk Replacer | 1.69 |
| Starch | 1.69 |
| Cinnamon | 8.78 |
| Total | 100.00 |

TABLE 11
Smear Formulation 1F

| Ingredient | Weight % |
|---|---|
| Sugar | 46.56 |
| Margarine | 21.16 |
| High Fructose Corn Syrup | 4.68 |
| Water | 13.22 |
| Salt | 0.51 |
| Flour | 1.69 |
| Nonfat Milk Replacer | 1.69 |
| Starch | 1.69 |
| Cinnamon | 8.78 |
| Total | 100.00 |

I. Dough Mixing and Sheeting

The dough was prepared by pre-blending the dry ingredients, including the shortening. The water was then added and the mixture was blended until a dough was formed. The dough was sheeted to the desired thickness. In this case, the dough thickness was approximately 8 mm.

II. Preparation of Smear

The smear was prepared by first mixing the sweeteners and fat. The water was then mixed in, followed by the remaining dry ingredients. The ingredients were mixed until a homogeneous mixture was obtained.

III. Formation of Cinnamon Swirls

Cinnamon swirls were prepared with 80 wt % of the dough formed in Step I and 20 wt % of the cinnamon smear prepared in Step II.

The sheeted dough was cut into 18″ strips to obtain a 5 ounce finished swirl. The cinnamon smear was evenly spread over the dough strip, leaving a 1″ space at one edge of the dough (the sealing edge). Water was then added to the sealing edge to moisten the dough in an amount effective to obtain adequate adhesion of the dough unto itself. The dough was then torpedo rolled from the top of the strip to the sealing edge. Next, the dough roll was cut transversely into 1″ pieces to form swirls 5 ounces in weight. The cinnamon swirls were then placed on sheet pans and frozen to a temperature of 0° F. or below. The frozen swirls were then removed from the freezer, placed on a pan lined with parchment paper, and baked in a convection oven at 325° F. for 18-20 minutes or until the internal temperature reached 185° F.

IV. Freeze-Thaw Cycling

Samples of frozen cinnamon swirl product with the smear formulations outlined in Tables 6 through 11 were removed from the freezer and placed in a temperature cycle box. The box was programmed to cycle between 0 F. and +30 F. every 20 hours (approximately 12 hours at 0 F. and 12 hours at +30 F.). The products were put through six complete temperature cycles. The samples were returned to the −10 F. freezer after completion of the six cycles. The frozen product was then evaluated for syruping.

V. Results

The results of this experiment are summarized below in Table 12.

TABLE 12

| Smear | | Moisture | Spread- | | Baked |
|---|---|---|---|---|---|
| Formulation | A_{w} | (%) | ability¹ | Syruping² | Appearance³ |
| 1A | 0.804 | 20.61 | 2 | 4 | 3 |
| 1B | 0.810 | 20.33 | 2 | 4 | 3 |
| 1C | 0.793 | 15.32 | 4 | 3 | 5 |
| 1D | 0.782 | 15.83 | 4 | 3 | 5 |
| 1E | 0.792 | 18.06 | 3 | 2 | 2 |
| 1F | 0.805 | 18.41 | 3 | 2 | 2 |

¹1 = 400 wet; 3 = easy to spread; 5 = too dry (tears dough)
²On a scale of 1-5, 5 is excessive syruping during frozen storage.
³On a scale of 1-5, 5 is driest smear appearance.

All of the cinnamon swirls made with smear formulations in Tables 6 through 11 were acceptable. However, cinnamon swirls made with smear formulations with increased water had excessive syruping during frozen storage. Furthermore, the increased moisture made it difficult to cut the dough roll into individual swirls without deforming the product.

Smear formulations that were too dry were difficult to spread, and could cause tearing of the dough, and had a dry baked appearance.

Smear formulations in Tables 10 and 11 (1E and 1F) were identified as the most spreadable, indulgent, wet cinnamon smear that exhibited minimal syruping during frozen storage and under abusive temperature cycling conditions.

### EXAMPLE 3

This experiment illustrates that thoroughly baked luxuriant biscuit swirls of varying sizes can be made from the said invention.

The following dough formulation was used in this experiment.

TABLE 13
Dough Formulation

| Ingredient | Weight % |
|---|---|
| Flour | 46.79 |
| Wheat Protein | 0.20 |
| Salt | 1.03 |
| Soda | 1.30 |
| SALP | 1.05 |
| SAPP | 0.60 |
| Sugar | 2.7 |
| Dough Conditioner | 0.80 |
| Butter Flavor | 0.10 |
| Caseinate | 0.90 |
| Soybean Oil | 0.07 |
| Shortening | 14.26 |
| Water | 30.2 |
| Total | 100.00 |

The following smear formulation was used in this experiment.

TABLE 14
Smear Formulation

| Ingredient | Weight % |
|---|---|
| Sugar | 46.56 |
| Butter | 21.16 |
| High Fructose Corn Syrup | 4.68 |
| Water | 13.22 |
| Salt | 0.51 |
| Flour | 1.69 |
| Nonfat Milk Replacer | 1.69 |
| Starch | 1.69 |
| Cinnamon | 8.78 |
| Total | 100.00 |

VI. Dough Mixing and Sheeting

The dough was prepared by pre-blending the dry ingredients, including the shortening. The water was then added and the mixture was blended until a dough was formed. The dough was sheeted to the desired thickness. In this case, the dough thickness ranged from 2.5 to 8 mm.

VII. Preparation of Smear

The smear was prepared by first mixing the sweeteners and fat. The water was then mixed in, followed by the remaining dry ingredients. The ingredients were mixed until a homogeneous mixture was obtained.

VIII. Formation of Cinnamon Swirls

Cinnamon swirls were prepared with 80 wt % of the dough formed in Step I and 20 wt % of the cinnamon smear prepared in Step II.

The sheeted dough was cut into strips to obtain finished biscuit swirls of varying sizes. The cinnamon smear was evenly spread over the dough strip, leaving a 1″ space at one edge of the dough (the sealing edge). Water was then added to the sealing edge to moisten the dough in an amount effective to obtain adequate adhesion of the dough unto itself. The dough was then torpedo rolled from the top of the strip to the sealing edge. Next, the dough roll was cut transversely into pieces of varying widths to obtain the desired finished weight. The cinnamon swirls were then placed on sheet pans and frozen to a temperature of 0° F. or below. The frozen swirls were then removed from the freezer, placed on a pan lined with parchment paper, and baked in a convection oven at 325° F. until the internal temperature reached 185° F.

TABLE 15
Results of Biscuit Swirl Size Variation Experiment

| | Dough | | | Average | |
|---|---|---|---|---|---|
| Prototype | Thickness | # Of | Cut | Product | Bake Time |
| # | (mm) | Curls | Width | Weight (oz) | (min) |
| 1 | 2.5 | 2.5-3.0 | 0.75″ | 0.5 | 7 |
| 2 | 2.5 | 2.5-3.0 | 1.0″ | 0.55 | 7 |
| 3 | 4.0 | 2.5-3.0 | 0.75″ | 1.0 | 10 |
| 4 | 4.0 | 2.5-3.0 | 1.0″ | 1.3 | 10 |
| 5 | 4.0 | 5.0-5.5 | 1.0″ | 5.2 | 20 |
| 6 | 4.0 | 5.0-5.5 | 1.5″ | 7.5 | 30 |
| 7 | 4.0 | 3.0-3.5 | 1.0″ | 1.9 | 20 |
| 8 | 4.0 | 3.0-3.5 | 1.5″ | 3.3 | 25 |
| 9 | 4.0 | 3.0-3.5 | 2.0″ | 3.7 | 25 |
| 10 | 4.0 | 3.0-3.5 | 2.5″ | 4.8 | 27 |
| 11 | 4.0 | 3.75-4.25 | 1.0″ | 3.4 | 23 |
| 12 | 4.0 | 3.75-4.25 | 1.5″ | 4.8 | 25 |
| 13 | 4.0 | 3.75-4.25 | 2.0″ | 6.6 | 35 |
| 14 | 8.0 | 2.5-3.0 | 0.5″ | 2.4 | 20 |
| 15 | 8.0 | 2.5-3.0 | 0.75″ | 3.3 | 22 |
| 16 | 8.0 | 2.5-3.0 | 1.0″ | 5.2 | 25 |
| 17 | 8.0 | 2.5-3.0 | 1.5″ | 7.2 | 30 |
| 18 | 8.0 | 2.5-3.0 | 2.0″ | 9.5 | 40 |
| 19 | 10.0 | 2.5-2.75 | 1.0″ | 6.1 | 31 |
| 20 | 10.0 | 2.5-2.75 | 1.5″ | 9.9 | 40 |
| 21 | 10.0 | 2.5-2.75 | 2.0″ | 11.2 | 40 |

TABLE 16
Baked Specific Volume (“BSV”) of Selected Prototypes

| | Dough | | Average | |
|---|---|---|---|---|
| | Thickness | | Product | |
| Prototype # | (mm) | # Of Curls | Weight (oz) | BSV |
| 2 | 2.5 | 2.5-3.0 | 0.55 | 3.174 |
| 5 | 8.0 | 2.5-3.0 | 5.2 | 3.067 |
| 6 | 8.0 | 2.5-3.0 | 7.2 | 3.235 |
| 19 | 10.0 | 2.5-2.75 | 6.1 | 3.038 |
| 20 | 10.0 | 2.5-2.75 | 9.9 | 2.923 |
| 21 | 10.0 | 2.5-2.75 | 11.2 | 2.815 |

All of the prototypes in Table 15 were thoroughly baked and had highly acceptable organoleptic characteristics at the indicated bake times. This example illustrates that thoroughly baked luxuriant cinnamon swirls of varying sizes can be made with the present invention.

The embodiments described herein are illustrative in nature and not intended to limit the scope of the invention. One skilled in the art will recognize that variations are possible without departing from the spirit or scope of the invention.

What is claimed is:

1. A frozen unproofed, unbaked biscuit swirl capable of being baked without an intermediate thawing or proofing step comprising:
a) a nonlaminated biscuit dough comprising flour, water, chemical leavening system, sugar and fat;
b) a smear layer having a water activity that is compatible with said biscuit dough;
said biscuit dough being formed in a swirl with the smear layer located between adjacent portions of the biscuit dough, said biscuit swirl being in a frozen, unproofed state.

2. The biscuit swirl of claim 1, wherein said biscuit dough further comprises protein.

3. The biscuit swirl of claim 2, wherein said biscuit dough comprises ingredients in the following amounts:

| | |
|---|---|
| flour | 40-60% |
| water | 20-30% |
| chemical leavening system | 1-5% |
| sugar | 3-10% |
| fat | 12-20% |
| protein | 1-10%. |

4. The biscuit swirl of claim 1, wherein said biscuit dough has a water activity of between 0.93 and 0.97, and the smear layer has a water activity between 0.77 and 0.84.

5. The biscuit swirl of claim l,wherein the overall weight of said biscuit swirl is less than 2 oz.

6. The biscuit swirl of claim 1, wherein the overall weight of said biscuit swirl is greater than 3 oz.

7. The biscuit swirl of claim 1, wherein the overall weight of said biscuit swirl is greater than 5 oz.

8. The biscuit swirl of claim 1, wherein the overall weight of said biscuit swirl is greater than 7 oz.

9. The biscuit swirl of claim 1, wherein said smear layer is sweet.

10. The biscuit swirl of claim 1,wherein said smear layer is savory.

11. The biscuit swirl of claim 1, wherein said smear layer is cheese flavored.

12. The biscuit swirl of claim 1, wherein said smear layer comprises
a) margarine or butter,
b) high fructose corn syrup,
c) sucrose, and
d) flavorant.

13. The biscuit swirl of claim 12, wherein said flavorant is cinnamon.

14. The biscuit swirl of claim 12, wherein said flavorant is maple syrup.

15. The biscuit swirl of claim 12, wherein said flavorant is a fruit flavor.

16. A method of preparing a biscuit swirl comprising
a) providing a frozen, unproofed, unbaked biscuit swirl of claim 1; and
b) baking said biscuit swirl without an intermediate thawing or proofing step.
